(19) United States
(12) Patent Application Publication
(10) Pub. No.: US 2022/0083781 A1
(43) Pub. Date: Mar. 17, 2022

(54) RULE ENABLED COMPOSITIONAL REASONING SYSTEM

(71) Applicant: NEC Laboratories America, Inc., Princeton, NJ (US)

(72) Inventors: Farley Lai, Santa Clara, CA (US); Asim Kadav, Mountain View, CA (US); Anupriya Prasad, San Diego, CA (US)

(21) Appl. No.: 17/464,099

(22) Filed: Sep. 1, 2021

Related U.S. Application Data
(60) Provisional application No. 63/079,513, filed on Sep. 17, 2020.

(51) Int. Cl. G06K 9/00; G06N 5/04

(52) U.S. Cl. CPC G06K 9/00718; G06K 2009/00738; G06N 5/04; G06K 9/00335

(57) ABSTRACT

A computer-implemented method is provided for compositional reasoning. The method includes producing a set of primitive predictions from an input sequence. Each of the primitive predictions is of a single action of a tracked subject to be composed in a complex action comprising multiple single actions. The method further includes performing contextual rule filtering of the primitive predictions to pass through filtered primitive predictions that interact with one or more entities of interest in the input sequence with respect to predefined contextual interaction criteria. The method includes performing, by a processor device, temporal rule matching by matching the filtered primitive predictions according to pre-defined temporal rules to identify complex event patterns in the sequence of primitive predictions.

### RELATED APPLICATION INFORMATION

This application claims priority to U.S. Pat. App. Pub. No. 63/079,513, filed on Sep. 17, 2020, incorporated herein by reference in its entirety.

### BACKGROUND

### Technical Field

The present invention relates to machine learning and more particularly to a rule enabled compositional reasoning system.

### Description of the Related Art

Reasoning tends to be formulated as a classification problem on the spatial, temporal and/or logic relations between entities of interest that requires training a sophisticated model over a large dataset composed of sequences of text, audio and/or video frames as input. A fundamental visual reasoning problem is the action recognition that aims to classify the human action in a video sequence. Despite recent success on image classification using deep learning, data collection for compositional reasoning problems remains intractable to capture complete representative compositions of primitive reasoning elements. For example, it is possible to collect data for primitive actions such as grabbing, walking, and exiting in the number of hundreds of videos. However, to reason about complex actions such as shoplifting, the data collection must include many possible scenarios combining all the three primitive actions in the order of millions of sequences to capture sufficient variety. This is not only resource demanding but also very costly to annotate the data and scale for business applications such as retail surveillance. Therefore, the prior art may seek synthesizing sequences of primitive reasoning elements that is unfortunately not realistic to work well in reality. Also in practice, almost every inference engine is going to suffer from false positives that are even harder to address with post-manually tuned thresholds for complex reasoning tasks. Last but not least, it is nontrivial for users to define custom reasoning targets for their specific application requirements since the data collection and model retraining are not necessarily affordable to extend on demand.

### SUMMARY

According to aspects of the present invention, a computer-implemented method is provided for compositional reasoning. The method includes producing a set of primitive predictions from an input sequence. Each of the primitive predictions is of a single action of a tracked subject to be composed in a complex action comprising multiple single actions. The method further includes performing contextual rule filtering of the primitive predictions to pass through filtered primitive predictions that interact with one or more entities of interest in the input sequence with respect to predefined contextual interaction criteria. The method includes performing, by a processor device, temporal rule matching by matching the filtered primitive predictions according to pre-defined temporal rules to identify complex event patterns in the sequence of primitive predictions.

According to other aspects of the present invention, a computer program product is provided for compositional reasoning. The computer program product includes a non-transitory computer readable storage medium having program instructions embodied therewith. The program instructions are executable by a computer to cause the computer to perform a method. The method includes producing, by a processor device of the computer, a set of primitive predictions from an input sequence. Each of the primitive predictions is of a single action of a tracked subject to be composed in a complex action comprising multiple single actions. The method further includes performing, by the processor device, contextual rule filtering of the primitive predictions to pass through filtered primitive predictions that interact with one or more entities of interest in the input sequence with respect to predefined contextual interaction criteria. The method also includes performing, by the processor device, temporal rule matching by matching the filtered primitive predictions according to pre-defined temporal rules to identify complex event patterns in the sequence of primitive predictions.

According to yet other aspects of the present invention, a computer processing system for compositional reasoning is provided. The computer processing system includes a memory device for storing program code. The computer processing system further includes a processor device operatively coupled to the memory device for running the program code to produce a set of primitive predictions from an input sequence. Each of the primitive predictions is of a single action of a tracked subject to be composed in a complex action comprising multiple single actions. The processor device further runs the program code to perform contextual rule filtering of the primitive predictions to pass through filtered primitive predictions that interact with one or more entities of interest in the input sequence with respect to predefined contextual interaction criteria. The processor device also runs the program code to perform temporal rule matching by matching the filtered primitive predictions according to pre-defined temporal rules to identify complex event patterns in the sequence of primitive predictions.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 shows an exemplary an exemplary rule enabled reasoning system, in accordance with an embodiment of the present invention;

FIG. 3 shows an exemplary method for compositional reasoning, in accordance with an embodiment of the present invention;

FIG. 4 is a diagram showing exemplary low level reasoning events applicable in a store, in accordance with an embodiment of the present invention; and

FIG. 5 shows an exemplary system for compositional reasoning, in accordance with an embodiment of the present invention.

### DETAILED DESCRIPTION OF PREFERRED EMBODIMENTS

Embodiments of the present invention are directed to a rule enabled compositional reasoning system.

Embodiments of the present invention provide an expressive rule engine for ease of composing complex custom reasoning targets based on models trained over realistic examples of primitive reasoning elements through feasible data collection and annotation. Specifically, this rule engine builds on top of any existing reasoning model and supports user defined rules to match complex patterns in temporal sequences of primitive predictions, each of which may be required to meet some contextual criteria in view of the entities of interest in the context. Since the rules typically specify particular orders and criteria to satisfy, false positives would be naturally suppressed without much tuning effort as before. Moreover, the compositional rules can be easily expressed in a regular language, allowing the user to extend the existing reasoning engine to recognize new reasoning targets without time-consuming data collection and model retraining.

Embodiments of the present invention can be considered to include at least the following three features. Feature 1: Efficient encoding of existing model prediction labels. Feature 2: Expressive rules to compose potentially compositional patterns to match prediction sequences. Feature 3: Optional contextual rules to qualify or rewrite primitive predictions only if some criteria are met with respect to entities of interest in the same context. For feature 1, the encoding of the prediction labels facilitates efficient processing of rule matching as in common regular expression implementations. For feature 2, knowledge of easy to learn regular expressions allows end users to timely define and apply custom rules to capturing application specific complex patterns. For feature 3, the qualification of the subject of primitive prediction is made conditional depending on the criteria met in a particular context, essentially capturing the contextual interactions with other objects of interest in the scene.

In summary, combining all of the above three features, the proposed rule engine complements existing machine learning models by offering the flexibility and extensibility to define custom prediction targets through space and time while reducing false positives as a side effect.

In an embodiment, a rule enabled reasoning system primarily includes an inference model and a rule engine. The inference model expects an input sequence of video, audio or text but is not limited to a single modality, and produces a sequence of primitive predictions that may be associated with one or more tracked subjects as tracks. Those primitive predictions on a per subject track basis will be processed first by applying contextual rules that specify how the prediction interacts with entities of interest in the context with respect to some criteria, and the filtering of the predictions that may be transformed as defined by users or applications. Those filtered predictions then go through the temporal rule matching for patterns described by the rules to be reported to the user.

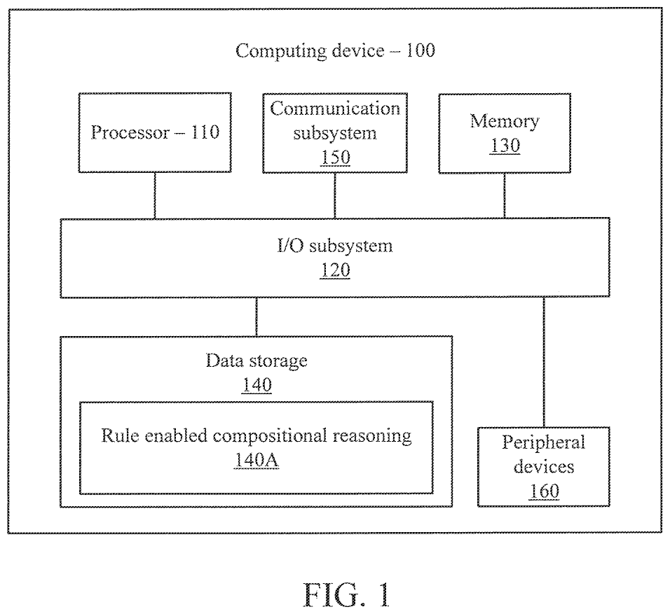

FIG. 1 is a block diagram showing an exemplary computing device 100, in accordance with an embodiment of the present invention. The computing device 100 is configured to perform rule enabled compositional reasoning.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for rule enabled compositional reasoning. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

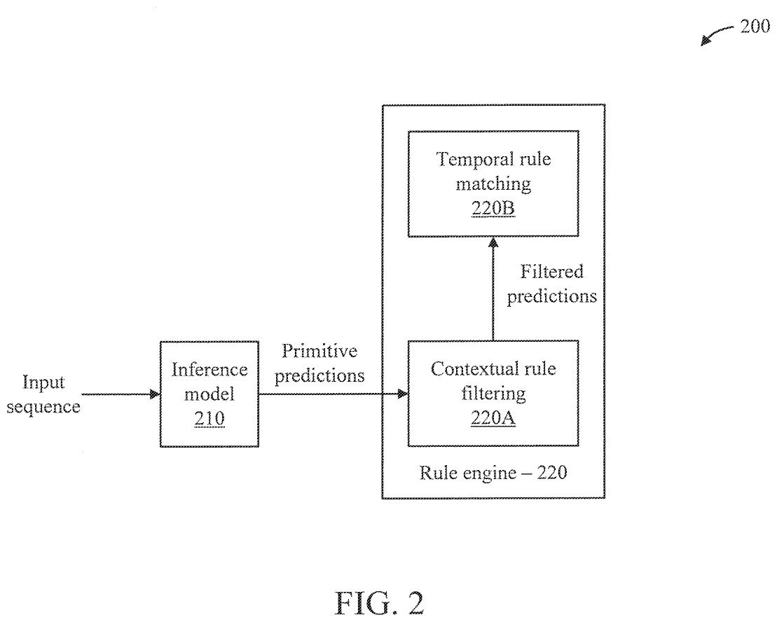

FIG. 2 shows an exemplary an exemplary rule enabled reasoning system 200, in accordance with an embodiment of the present invention.

The system 200 includes an inference model 210, a rule engine 220 having a contextual rule filtering block 220A and a temporal rule matching block 220B. The system 200 accepts an input sequence of, for example, one or more of video, audio, and/or text 201, and outputs rule matched patterns 299.

The inference model 210 expects an input sequence of video, audio and/or text 201 and is not limited to a single modality, and produces a sequence of primitive predictions 211 that may be associated with one or more tracked subjects as tracks. Those primitive predictions 211 on a per subject track basis will be processed first by applying contextual rules that specify how the prediction interacts with entities of interest in the context with respect to some criteria, and the filtering 220A of the predictions 211 that may be transformed as defined by users or applications. Those filtered predictions 221 then go through the temporal rule matching block 220B for patterns 299 described by the rules to be reported to the user.

Embodiments of the present invention can complement existing inference models by incorporating a rule engine that requires building several internal modules.

(1) Contextual Rule Filtering

The contextual rule involves the state of the subject track inducing the predictions to consider. On the other hand, the entities of interest in the modality that the inference model operates on and their interactions with the subject track serve as the rule criteria to evaluate.

The procedures are detailed in the following steps.

(1.1) Admit Primitive Input Prediction

The admission depends on the state of the subject track and the induced prediction. For example, the primitive input prediction can be restricted to some subset of prediction labels while the subject track may need to be some object class to be considered.

(1.2) Define Entities of Interest

The entities of interest can be defined by users through a graphic user interface that facilitates marking relevant entities in the modality that the inference model operates on.

Each of the entities may be assigned a name for ease of reference in specifying the rule criteria.

(1.3) Specify Contextual Rule Criteria and Filters

The rule criteria may reference one or more entities of interest by name as defined with respect to the admit primitive input prediction.

For each referenced entity, some contextual interaction criteria can be specified and should be evaluable through some metric. A straightforward example is the intersection over union (IoU) metric that evaluates the overlap between the tracked subject inducing the prediction and the referenced entity of interest.

The filter operations are application specific. A possible use case is to rewrite the prediction as the subject is close to some entity in the input scene with the IoU metric above some threshold.

(1.4) Apply Contextual Rule Filtering on Prediction Sequences

When the criteria are met as evaluated to hold (negative condition can be specified instead), the corresponding rule filter operation is applied and the input prediction sequence may be transformed for the next phase of temporal rule matching.

(2) Temporal Rule Matching

A focus of temporal rule matching is to efficiently identify complex patterns in the filtered primitive input sequences by contextual rules. To serve this purpose, the predictions must be represented in a string form for the regular expression implementation to efficiently match the patterns. The following steps demonstrate a possible realization of this element.

(2.1) Build a Temporal Rule Engine Codebook

Collect primitive prediction labels from the inference model that the rule engine builds on.

Encode the labels into characters in the regular expression alphabet.

Create a codebook describing the mapping between the labels and characters.

(2.2) Compile User Defined Rules

Encode the labels in the rules according to the created codebook

Nested rules can be expanded if necessary for encoding

Compile resulting rules with the regular expression implementation following the supported regular expression syntax

(2.3) Apply Temporal Rule Matching

Given an input prediction sequence filtered by contextual rules, the regular expression implementation then matches the patterns described by the user defined temporal rules and outputs the matching results to indicate whether the complex reasoning target exists in the prediction sequence.

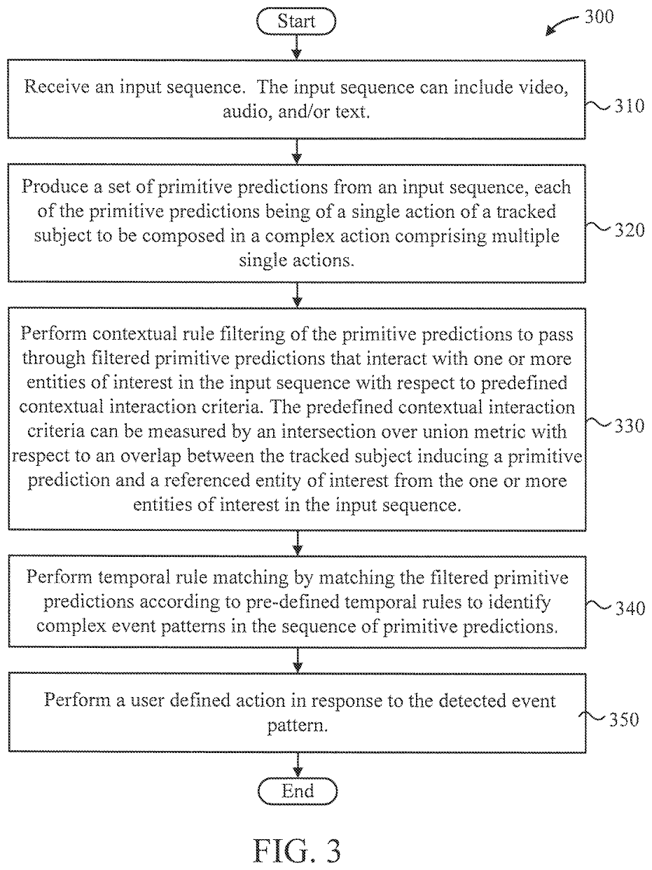

FIG. 3 shows an exemplary method 300 for compositional reasoning, in accordance with an embodiment of the present invention.

At block 310, receive an input sequence. The input sequence can include video, audio, and/or text.

At block 320, produce a set of primitive predictions from an input sequence, each of the primitive predictions being of a single action of a tracked subject to be composed in a complex action comprising multiple single actions.

At block 330, perform contextual rule filtering of the primitive predictions to pass through filtered primitive predictions that interact with one or more entities of interest in the input sequence with respect to predefined contextual interaction criteria. In an embodiment, the predefined contextual interaction criteria can be measured by but not limited to an intersection over union metric with respect to an overlap between the tracked subject inducing a primitive prediction and a referenced entity of interest from the one or more entities of interest in the input sequence. As a setup procedure for performing the contextual rule filtering, predefine the entities of interest and the filtered primitive predictions to admit for further processing, and specify the rule criteria and operations. The filtered primitive predictions are each in a string form.

At block 340, perform temporal rule matching by matching the filtered primitive predictions according to pre-defined temporal rules to identify complex event patterns in the sequence of primitive predictions. At a setup procedure for performing the temporal rule matching, build a rule engine codebook, and compile user defined rule patterns.

At block 350, perform a user defined action in response to the detected event pattern. For example, in an embodiment, control a motor vehicle system to avoid an impending collision responsive to the complex patterns indicating the impending collision.

Description in general use cases (not necessarily for action recognition) may use primitive predictions and complex event patterns as follows:

Inference model→primitive predictions→filtered primitive prediction sequence→complex event patterns→user defined action

In the context of action recognition, the following can apply:

Inference model→primitive action detections→filtered primitive action sequence→complex custom action patterns→user defined reaction

A description will now be given regarding some of the many contributions of the present invention, in accordance with embodiments of the present invention.

Embodiments of the present invention perform reasoning at the object level by using regular expressions over sequence of detections.

Embodiments of the present invention use large action recognition datasets to learn individual actions.

Embodiments of the present invention detect complex scenarios by using a regex evaluator over detections.

Embodiments of the present invention provide a frontend for user to input any regex and built a real-time regex evaluation system in the backend

A description will now be given regarding some of the many benefits of the present invention, in accordance with embodiments of the present invention.

Embodiments of the present invention do not require collecting a large number of action sequences representing complex events for re-training existing models.

Embodiments of the present invention are easily extensible and composable to include action, object, location rules.

Embodiments of the present invention are able to reduce false positives with stricter rules

A description will now be given regarding the action recognition reasoning engine, in accordance with an embodiment of the present invention.

Embodiments of the present invention create custom rules based on interested actions to capture sequence of detections

The rule-based approach of the present invention uses regular expression style for temporal and additive logic to match the sequence of human actions/objects for every detected object track. Embodiments of the present invention can include the ability to use actions, objects, or landmark keypoints (e.g. door), action duration, as rule elements.

Regex Sequence Parts:
(1) Actions as strings: “walking”, “counting_money”, etc.
(2) Time in seconds to match for how long the action was detected: “>=3” means greater than or equal to 3 seconds
(3) Linking Parameter : “→” used to specify an action being followed by another action
(4) Frequency Operators: “*” and “+” to specify if an action is detected zero or more times, and at least once in the sequence respectively.

Consider the following sequence:
Action_1>=Time_1(s)→Action_2>=Time_2(s)→Action_3*→Action_4+

Action 1 occurs for at least Time_1 seconds, which is followed by Action_2 occurring for Time_2 seconds, which is further followed by Action_3 occurring 0 or more times, and Action_4 occurring at least once.

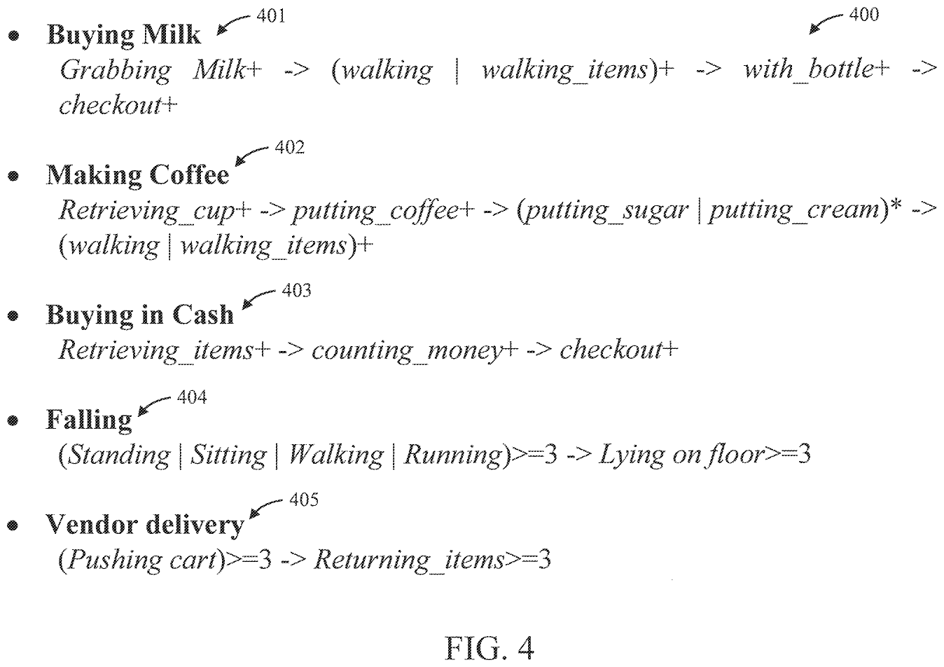

FIG. 4 is a diagram showing exemplary low level reasoning events 400 applicable in a store, in accordance with an embodiment of the present invention.

The low level reasoning events 400 include: buying milk 401; making coffee 402; buying in cash 403; falling 404; and vendor delivery 405.

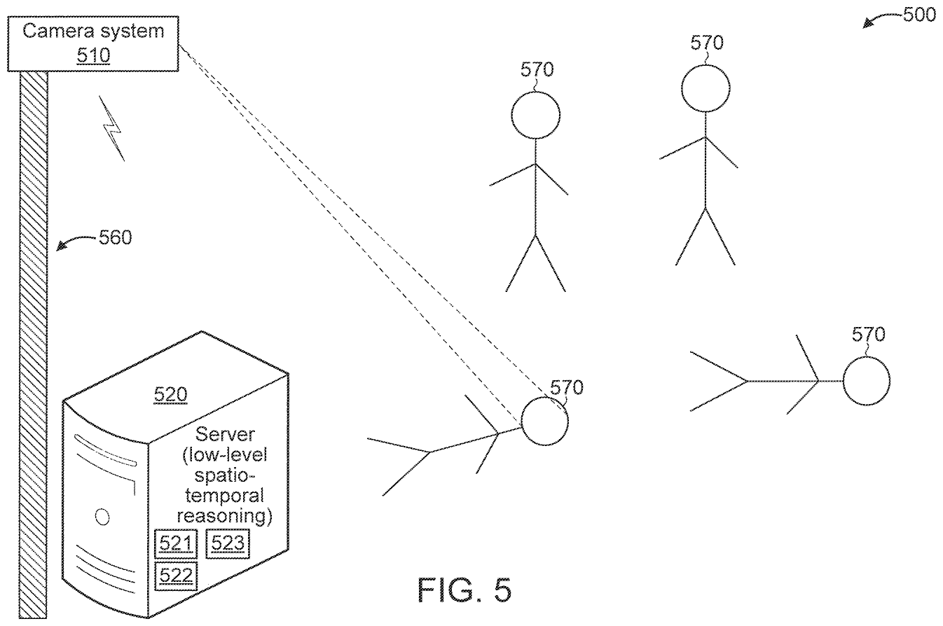

FIG. 5 shows an exemplary system 500 for compositional reasoning, in accordance with an embodiment of the present invention.

The system 500 includes a camera system 510. While a single camera system 510 is shown in FIG. 5 for the sakes of illustration and brevity, it is to be appreciated that multiple camera systems can be also used, while maintaining the spirit of the present invention.

In the embodiment of FIG. 1, the camera system 510 is mounted on a mounting entity 560. For the sake of illustration, the mounting entity 560 is a pole 560. While a pole 560 is shown for the sake of illustration, any other mounting entity can be used, as readily appreciated by one of ordinary skill in the art given the teachings of the present invention provided herein, while maintaining the spirit of the present invention. For example, the camera system 510 can be mounted on a building, a drone, and so forth. The preceding examples are merely illustrative. It is to be appreciated that multiple mounting entities can be located at control hubs and sent to a particular location as needed.

The camera system 510 can be a wireless camera system or can use one or more antennas included on the pole 560 (or other mounting entity (e.g., building, drone, etc.) to which the camera system 510 is mounted or proximate).

The system 500 further includes a server 520 for low-level spatio-temporal reasoning. The server 520 can located remote from, or proximate to, the camera system 510. The server 520 includes a processor 521, a memory 522, and a wireless transceiver 523. The processor 521 and the memory 522 of the remove server 520 are configured to perform low-level spatio-temporal reasoning based on images received from the camera system 510 by the (the wireless transceiver 523 of) the remote server 520. To that end, the processor 521 and memory 522 can be configured to include components of a compositional reasoning system. In this way, the complex actions of a person 570 can be recognized from simpler actions. Here, falling can be detected from, e.g., walking or running.

The use of a video camera as an input device pertains to one of multiple possible different input modalities that can be used for a reasoning system in accordance with an embodiment of the present invention. In other embodiments, the objects and/or actions in video can be transformed to representative text and the text provided as the input to a system in accordance with an embodiment of the present invention. These and other environments and corresponding inputs to which the present invention can be applied are readily determined by one of ordinary skill in the art given the teachings of the present invention provided herein.

In other embodiments, a vehicle system such as stability, braking, steering, and/or accelerating can be controlled responsive to a prediction of a complex action by the present invention. For example, a complex action concluding with an accident can be avoided by acting on the prediction before the occurrence of the accident.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed. The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for compositional reasoning, comprising:
producing a set of primitive predictions from an input sequence, each of the primitive predictions being of a single action of a tracked subject to be composed in a complex action comprising multiple single actions;
performing contextual rule filtering of the primitive predictions to pass through filtered primitive predictions that interact with one or more entities of interest in the input sequence with respect to predefined contextual interaction criteria; and
performing, by a processor device, temporal rule matching by matching the filtered primitive predictions according to pre-defined temporal rules to identify complex event patterns in the sequence of primitive predictions.

2. The computer-implemented method of claim 1, wherein the input sequence comprises at least one of video, audio, and text.

3. The computer-implemented method of claim 1, wherein the predefined contextual interaction criteria is measured by an intersection over union metric with respect to an overlap between the tracked subject inducing a primitive prediction and a referenced entity of interest from the one or more entities of interest in the input sequence.

4. The computer-implemented method of claim 1, further comprising, as a setup procedure for performing the contextual rule filtering, predefining the entities of interest and the filtered primitive predictions to admit for further processing.

5. The computer-implemented method of claim 1, wherein the filtered primitive predictions are each in a string form.

6. The computer-implemented method of claim 1, further comprising encoding primitive prediction labels into characters in a regular expression alphabet.

7. The computer-implemented method of claim 6, further comprising creating a codebook describing a mapping between the primitive prediction labels and the characters.

8. The computer-implemented method of claim 1, further comprising controlling a motor vehicle system to avoid an impending collision responsive to the complex patterns indicating the impending collision.

9. A computer program product for compositional reasoning, the computer program product comprising a non-transitory computer readable storage medium having program instructions embodied therewith, the program instructions executable by a computer to cause the computer to perform a method comprising:
producing, by a processor device of the computer, a set of primitive predictions from an input sequence, each of the primitive predictions being of a single action of a tracked subject to be composed in a complex action comprising multiple single actions;
performing, by the processor device, contextual rule filtering of the primitive predictions to pass through filtered primitive predictions that interact with one or more entities of interest in the input sequence with respect to predefined contextual interaction criteria; and
performing, by the processor device, temporal rule matching by matching the filtered primitive predictions according to pre-defined temporal rules to identify complex event patterns in the sequence of primitive predictions.

10. The computer program product of claim 9, wherein the input sequence comprises at least one of video, audio, and text.

11. The computer program product of claim 9, wherein the predefined contextual interaction criteria is measured by an intersection over union metric with respect to an overlap between the tracked subject inducing a primitive prediction and a referenced entity of interest from the one or more entities of interest in the input sequence.

12. The computer program product of claim 9, further comprising, as a setup procedure for performing the contextual rule filtering, predefining the entities of interest and the filtered primitive predictions to admit for further processing.

13. The computer program product of claim 9, wherein the filtered primitive predictions are each in a string form.

14. The computer program product of claim 9, further comprising encoding primitive prediction labels into characters in a regular expression alphabet.

15. The computer program product of claim 14, further comprising creating a codebook describing a mapping between the primitive prediction labels and the characters.

16. The computer program product of claim 9, further comprising controlling a motor vehicle system to avoid an impending collision responsive to the complex patterns indicating the impending collision.

17. A computer processing system for compositional reasoning, comprising:
a memory device for storing program code; and
a processor device operatively coupled to the memory device for running the program code to:
produce a set of primitive predictions from an input sequence, each of the primitive predictions being of a single action of a tracked subject to be composed in a complex action comprising multiple single actions;
perform contextual rule filtering of the primitive predictions to pass through filtered primitive predictions that interact with one or more entities of interest in the input sequence with respect to predefined contextual interaction criteria; and
perform temporal rule matching by matching the filtered primitive predictions according to pre-defined temporal rules to identify complex event patterns in the sequence of primitive predictions.

18. The computer processing system of claim 17, wherein the input sequence comprises at least one of video, audio, and text.

19. The computer processing system of claim 17, wherein the predefined contextual interaction criteria is measured by an intersection over union metric with respect to an overlap between the tracked subject inducing a primitive prediction and a referenced entity of interest from the one or more entities of interest in the input sequence.

20. The computer processing system of claim 17, wherein the filtered primitive predictions are each in a string form.
